(19) United States
(12) Patent Application Publication
(10) Pub. No.: US 2026/0037577 A1
(43) Pub. Date: Feb. 5, 2026

(54) QUERY PLANNER AGENT FOR MULTIMEDIA SYSTEM

(71) Applicant: Roku, Inc., San Jose, CA (US)

(72) Inventors: Kapil Kumar, London (GB); Srimaruti Manoj Nimmagadda, Saratoga, CA (US); Rahul Agarwal, London (GB); Nitish Aggarwal, Sunnyvale, CA (US)

(73) Assignee: Roku, Inc., San Jose, CA (US)

(21) Appl. No.: 18/790,143

(22) Filed: Jul. 31, 2024

(51) Int. Cl. G06F 16/78; G06F 16/738; G10L 15/22; H04N 21/472

(52) U.S. Cl. CPC G06F 16/7867; G06F 16/738; G10L 15/22; H04N 21/472; G10L 2015/223

(57) ABSTRACT

A method is described and includes receiving by a query planner agent of a query response system a user query comprising a request for a response; determining a type of the received user query; identifying one of a plurality of response modules comprising the query response system based on the determined type of the received user query; and forwarding the received user query to the identified one of the plurality of response modules. In example embodiments, the determined type of the received user query comprises one of a lexical query, a categorical query, an explanatory query, and a multistep query, each of which is routed to a different response module.

### TECHNICAL FIELD

This disclosure relates to multimedia systems, and more specifically, to a query planner agent for such systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an example multimedia system, according to some embodiments of the disclosure.

FIG. 2 illustrates a block diagram of an example media device, according to some embodiments of the disclosure.

FIG. 3 illustrates an example query response system including a query planner agent for a multimedia system, according to some embodiments of the disclosure.

FIG. 4 is a flow chart illustrating example operations performed by a query planner agent in a multimedia system, according to some embodiments of the disclosure.

FIG. 5 is a block diagram of an example computing device, according to some embodiments of the disclosure.

### DETAILED DESCRIPTION

### Overview

Multimedia systems, such as digital streaming platforms, may provide one or more mechanisms by which a user can interact with the system by submitting a query thereto. For example, a text input device may be provided for enabling a user to type the user's query and submit it to the system. Additionally and/or alternatively, a voice assistant may be provided to enable a user to interact with the system using the user's voice. Voice assistants enable users to use voice commands to perform a task, such as to change a setting of a device, retrieve information, request content item(s), make a purchase, offer information, etc. Voice assistants may include components such as automatic speech recognition, natural language understanding, and dialogue state tracking. Automatic speech recognition may use acoustic and language models to convert audio signals of user utterances into natural language text.

Natural language understanding may be implemented to extract intent and meaning behind a user's spoken words. Natural language understanding may include natural language processing functions, such as intent classification, entity extraction, and content analysis. As used herein, an intent may specify a task classification, a type of task, or an identification of a specific task the user is trying to perform. An entity associated with the intent may specify a parameter for the task. An entity may have a value that is selected from a set of values for the parameter.

It will be recognized that a user who submits a query to the system will expect a corresponding response. A response may include, for example, one or more of a list of content items that correspond to the query, a link to a content item that corresponds to the query, or a text or an audio response that answers a question posed by the query, to name a few. Often, the type of response expected will depend on the type of query submitted.

In one example, a user may submit to a multimedia system, either by voice or text, a query that includes a single entity, such as the full or partial name of a movie, a series, a character, an actor, a director, etc. Examples of such queries include:
“tom cruise”
“spielberg”
“spiderman”
“yellowstone”
“kung fu panda”
   This type of query is referred to herein as a lexical query. The expected response to a lexical query may be a list of content items relevant to the user's query (e.g., a list of movies in which Tom Cruise appears, in the case of the “tom cruise” query).

In another example, a user may submit to a multimedia system, either by voice or text, a query that includes a description of a type or category of content, such as a genre, a concept, or a location, for example. Examples of such queries include:
“action movies”
“movies set in ireland”
“comedies”
“shows about cults”
   This type of query is referred to herein as a categorical query. The expected response to a categorical query may be a list of content items relevant to the user's query (e.g., a list of movies that are set in Ireland in response to the “movies set in ireland” query).

In yet another example, a user may submit to a multimedia system, either by voice or text, a query that requires a response more expressive, open-ended and/or free-form than a list of content items. Examples of such queries include:
“has spiderwick chronicles been released”
“what is the series severance about”
“what actor has starred in the most romantic comedies in the past decade”
   This type of query is referred to herein as an exploratory query. The expected response to an exploratory query may be a free-form response to the question posed by the user in the query (e.g., detailed information regarding the release date and streaming information for The Spiderwick Chronicles series in response to the “has the spiderwick chronicles been released” query).

In yet another example, a user may submit to a multimedia system, either by voice or text, a query that combines one or more of the previous types of queries. An example of such a query includes “movies of the actor who played lawyer in breaking bad.” This type of query is referred to herein as a multistep query. The example query provided above is a combination of an exploratory query (e.g., “who is the actor that played the lawyer in breaking bad”) and followed by a lexical query on the response to the exploratory query (e.g., “bob odenkirk”).

In accordance with features of embodiments described herein, a query planner agent may be provided in a multimedia system for characterizing user queries and forwarding the queries to respective ones of expert modules for responding to the type of query. In particular embodiments, query planner agent may be implemented using a large language model. Large language models are artificial neural networks that utilize transformer architecture to implement computational models. Large language models are capable of natural language processing tasks such as classification by learning statistical relationships from vast amounts of text during a computationally intensive self-supervised and semi-supervised training process. Fine tuning and/or prompt engineering may be used to adapt a large learning model for use for a specific task, such as a query planner agent as will be described in detail below. With properly generated prompts, a large language model trained on vast amounts of text can pick up linguistic cues to classify a query provided by a user. In response to the generated prompt, the large language model can reason correctly and forward the query to an appropriate module for providing a response to the query.

### Example Multimedia System

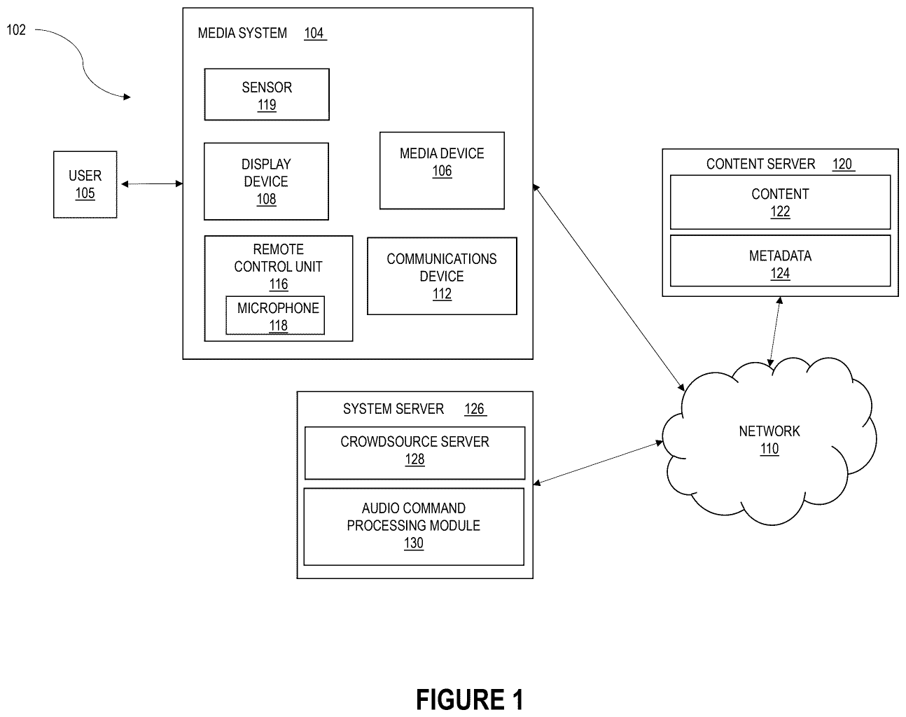

FIG. 1 illustrates a block diagram of an example multimedia system 102 according to some embodiments described herein. In a non-limiting example, multimedia system 102 may be directed to digital streaming media; however, embodiments described herein may be applicable to any type of media instead of or in addition to streaming media, as well as any type of mechanism, means, protocol, method, and/or process for distributing media.

Multimedia system 102 may include one or more media systems, such as media system 104. Media system 104 may represent a family room, a kitchen, a backyard, a home theater, a school classroom, a library, a car, a boat, a bus, a plane, a stadium, a movie theater, an auditorium, a bar, a restaurant, an extended reality (XR) space, and/or any other location or space where it may be desirable to receive, interact with, and/or play streaming content. Users, such as a user 105, may interact with media system 104 as described herein to select, view, interact with, and/or otherwise consume content.

Each media system 104 may include one or more media devices, such as media device 106, each of which may be coupled to one or more display devices, such as display device 108 (which may be implemented as an A/V device). It will be noted that terms such as “coupled,” “connected,” “attached,” “linked,” “combined,” as well as similar terms, may refer to physical, electrical, magnetic, local, and/or other types of connections, unless otherwise specified herein.

Media device 106 may include a streaming media device, DVD or BLU-RAY device, audio/video playback device, cable box, an XR device (which may include one or more of a VR device, an AR device, and an MR device), and/or digital video recording device, for example. Display device 108 may include a monitor, a television, a computer, a smart phone, a tablet, a wearable (e.g., a watch, glasses, goggles and/or an XR headset), an appliance, an Internet of things (IoT) device, and/or a projector, for example. In some embodiments, media device 106 may be a part of, integrated with, operatively coupled to, and/or connected to one or more respective display devices, such as display device 108.

Media device 106 may be configured to communicate with network 110 via a communications device 112. Communications device 112 may include, for example, a cable modem or satellite TV transceiver. Media device 106 may communicate with the communications device 112 over a link that may include wireless (e.g., Wi-Fi) and/or wired connections.

In various embodiments, network 110 may include, without limitation, wired and/or wireless intranet, extranet Internet, cellular, Bluetooth, infrared, and/or any other short range, long range, local, regional, and/or global communications mechanism, means, approach, protocol, and/or network, as well as any combinations thereof.

Media system 104 may include a remote control device 116. Remote control device may include and/or be incorporated into any component, part, apparatus, and/or method for controlling media device 106 and/or display device 108, such as a remote control, a tablet, a laptop computer, a smartphone, a wearable, on-screen controls, integrated control buttons, audio controls, XR equipment, and/or any combination thereof, for example, In one embodiment, remote control device 116 wirelessly communicates with media device 106 and/or display device 108 using any wireless communications protocol. Remote control device 116 may include a microphone 118. Media system 104 may also include one or more sensors, such as sensor 119, which may be deployed for tracking movement of user 105, such as in connection with XR applications. In particular embodiments, sensor 119 may include one or more of a gyroscope, a motion sensor, a camera, an IMU, and a biometric sensor, for example. Sensor 119 may also include one or more sensing devices for sensing biometric characteristics associated with sympathetic arousal, including one or more of heart rate variability (HRV), electrodermal activity (EDA), pupil opening, and/or eye movement. In some embodiments, sensors, such as sensor 119, may be incorporated into a device to be worn by users, such as a headset or vest. In particular embodiments, sensor 119 may comprise any sort of XR device.

Multimedia system 102 may include a plurality of content servers 120, which may also be referred to as content providers or sources. Although only one content server 120 is shown in FIG. 1, multimedia system 102 may include any number of content servers 120, each of which may be configured to communicate with network 110. Content servers 120 may be managed by one or more content providers. Each content server 120 may store content 122 and metadata 124. Content 122 may include media content, such as audio content, video content, image content, XR (e.g., VR, AR, and/or MR) content, gaming application content, advertising content, software content, and/or any other content or data objects in electronic form. Features or attributes of content 122 may include but are not limited to popularity, topicality, trend, statistical change, most-talked or most-discussed about, critics ratings, viewers ratings, length/duration, demographic-specific popularity, segment-specific popularity, region-specific popularity, cost associated with a content item, revenue associated with a content item, subscription associated with a content item, and amount of advertising, for example.

In particular embodiments, metadata 124 may include data about content 122. For example, metadata 124 may include but is not limited to such information pertaining or relating to content 122 as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, scene and video understanding, and emotional understanding of the scene based on visual and dialogue cues, for example. Metadata 124 may additionally or alternatively include links to any such information pertaining to or relating to content 122. Metadata 124 may additionally or alternatively include one or more indices of content 122.

Multimedia system 102 may include one or more system servers 126, which operate to support media devices 106 from the cloud. In particular embodiments, structural and functional aspects of system servers 126 may wholly or partially exist in the same or different ones of system servers 126.

Media devices, such as media device 106, may exist in numerous media systems, such as media system 104. Accordingly, media devices 106 may lend themselves to crowd sourcing embodiments and system servers 126 may include one or more crowdsource servers 128. System servers 126 may also include an audio command processing module 130. As noted above, remote control device 116 may include a microphone 118, which may receive audio data from user 105 as well as from other sources, such as display device 108. In some embodiments, media device 106 may be audio responsive and the audio data may represent verbal commands from user 105 to control media device 106 as well as other components in media system 104, such as display device 108.

In some embodiments audio data received by microphone 118 is transferred to media device 106, which is then forwarded to audio command processing module 130. The audio command processing module 130 may operate to process and analyze the received audio data to recognize a verbal command from user 105. Audio command processing module 130 may then forward the verbal command to media device 106 for processing. In some embodiments, audio data may be additionally or alternatively processed and analyzed by an audio command processing module in media device 106 and system servers 126 may cooperate to select one of the verbal commands to process.

### Example Media Device for Multimedia System

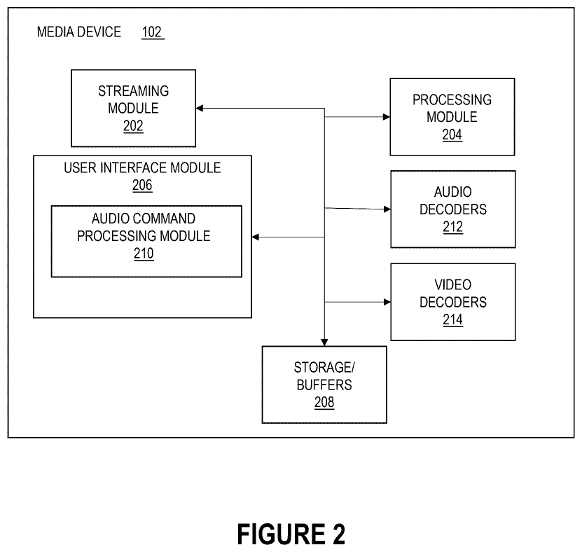

FIG. 2 illustrates a block diagram of an example media device 106 according to some embodiments. Media device 106 may include a streaming module 202, processing module 204, a user interface module 206, and storage/buffers 208. As noted above, user interface module 206 may include an audio command processing module 210.

As shown in FIG. 2, media device 106 may also include one or more audio decoders 212 and one or more video decoders 214. Each audio decoder 212 may be configured to decode one or more audio formats, including but not limited to AAC, HE-AAC, AD3 (Dolby Digital), EAC3 (Dolby Digital Plus), WMA, WAV, PCM, MP3, OGG GSM, FLAC, AU, AIFF, and/or VOX, for example. Similarly, each video decoder 214 may be configured to decode video of one or more video formats, including but not limited to MP4 (e.g., mp4, m4a, m4v, f4v, f4a, m4b, m4r, f4b, mov), 3GP (e.g., 3gp, 3gp2, 3g2, 3gpp, 3gpp2), OGG (e.g., ogg, oga, ogv, ogx), WMV (e.g., wmv, wma, asf), WEBM, FLV, AVI, QuickTime, HDV, MXF, MPEG-TS, MPEG-2 PS, MPEG-2 TS, WAV, Broadcast WAV, LXF, GXF, and/or VOB, for example. Each video decoder 214 may include one or more video codecs, such as H.263, H.264, H.265, HEV, MPEG1, MPEG2, MPEG-TS, MPEG-4, Theora, 3GP, DV, DVCPRO, DVCProHD, IMX, XDCAM HD, XDCAM HD422, AND XDCAM EX, for example.

Referring now to both FIGS. 1 and 2, in some embodiments, user 105 may interact with media device 106 via, for example, remote control device 116. For example, user 105 may use remote control device 116 to interact with user interface module 206 of the media device 106 to select content, such as a movie, TV show, music, book, application, game, etc. The streaming module 202 of media device 106 may request the selected content from content servers 120 over network 110. Content servers 120 may transmit the requested content to the streaming module 202. Media device 106 may transmit the received content to the display device 108 for playback to user 105.

In streaming embodiments, streaming module 202 may transmit content to display device 108 in real time or near real time as it receives such content from content servers 120. In non-streaming embodiments, media device 106 may store content received from content servers 120 in storage/buffers 208 for later playback on display device 108, for example.

### Example Query Response System for Multimedia System

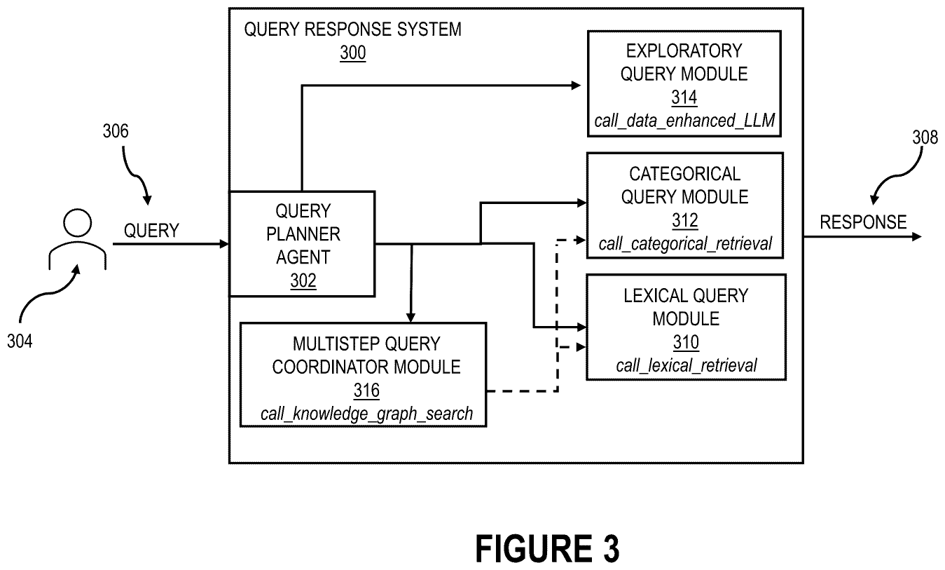

FIG. 3 illustrates a query response system 300 including a query planner agent 302 for processing text and/or verbal queries 304 from users, represented in FIG. 3 by a user 306, according to some embodiments of the disclosure. All or part of system 300 may be implemented by a multimedia system substantially identical in all relevant respects to multimedia system 102 (FIG. 1). In some embodiments, system 300 may comprise a content retrieval system and may include a voice assistant for enabling user 306 to interact with system 300 via voice queries to retrieve content items to consume via a television, a smart speaker, or a media player, for example. As described above with respect to media system 102, system 300 may enable users to access and view thousands to millions or more content items through text or voice queries 304. Content items may include media content, such as audio content, video content, image content, augmented reality content, virtual reality content, mixed reality content, gaming content, textual content, interactive content, etc. Examples of content items may include books, audio books, music, movies, television series, mini-series, advertisements, short films, films, documentaries, podcasts, audio clips, radio programming, games, interactive content, immersive content, etc. As will be described in greater detail below, query response system 300 may produce response 308, which may be output to a user, such as user 304.

For purposes that will be described in greater detail below, query response system 300 further includes a lexical query module 310, a categorical query module 312, an exploratory query module 314, and a multistep query coordinator module 316. At a high level, and as will be described, in response to a query, such as query 306, query planner agent 302 classifies (i.e., determines a type of) the query and forwards the query (e.g., via a function call) to the appropriate one of the modules 310-316 for generating a response, such as response 308. In general, lexical query module 310 is implemented using a conventional database search engine designed to perform lexical searches in connection with lexical queries. Similarly, categorical query module 312 is implemented using a conventional database search engine designed to perform categorical searches in connection with categorical queries. Exploratory query module 314 is implemented using an LLM and is used to provide responses to exploratory queries. Finally, multistep query coordinator module 316 may also be implemented using an LLM and is used to coordinate responses to multistep queries. It will be recognized that while LLMs comprising module 314 and coordinator module 316 (as well as query planner agent 302) could be used to respond to any given query, LLMs are more expensive than the conventional search engines that may be used to perform straightforward lexical and categorical searches as may be performed by modules 310 and 312; therefore, a goal of the query planner agent 302 is to call one of modules 310 and 312 to respond to as many queries as possible, reserving calls to module 314 and coordinator module 316 for user queries that require a more in depth processing afforded by LLMs.

### Example Search Engine Retrieval Strategies

Different retrieval strategies may be available for retrieving content items in response to a query. One example of a retrieval strategy is lexical match. In lexical match search, the query may be processed to extract keywords, and the keywords may be lexicographically matched against a database of content items and associated keywords. Content items which may have the most number of keyword lexicographic matches may be returned in response to the query.

Another example of a retrieval strategy is semantic retrieval. Semantic retrieval may utilize a model to interpret the semantic meaning or context of a query and find content items that may match with the query. A model may implement natural language processing to interpret the query. A model may involve neural networks (e.g., transformer-based neural networks). A model may include a large language model (LLM).

Yet another example of a retrieval strategy is graph embedding based approach to content item retrieval. A graph embedding based approach may find a subgraph of a graph of content items which may be engaging to the user for a given query. In some cases, the graph may model relationships between content items. In some cases, the graph embedding based approach may utilize the graph to identify content items which may not be directly connected to an initial set of content items that matches the query.

Yet another example of a retrieval strategy may involve returning a fixed set or list of results for a particular query. The set or list of results may be curated by editor(s), hardcoded, or predetermined. For example, a query for “presidential debate” may retrieve predetermined content items which are tapings of the most recent presidential debates, and not content items related to presidential inaugurations or state of the union addresses.

Yet another example of a retrieval strategy may involve searching for content items based on user query history and/or user interactivity history information. For example, content items may be retrieved based on whether the user has launched a particular content item in the past.

Yet another example of a retrieval strategy may involve searching for content items based on user profile or user characteristic(s). For example, content items may be retrieved based on demographic information about the user.

Yet another example of a retrieval strategy may involve collaborative filtering. Content items may be retrieved based on interactivity with the content platform and characteristics about various users on the system. For example, content items may be retrieved based on content items viewed by users who may be similar to the current user making the query. Users may be similar to the current user if the users behaved similarly on the content platform. Users may be similar to the current user if the users are socially connected with the current user.

Yet another example of a retrieval strategy may involve returning a number of content items from each clusters or buckets of content items. For example, content items may be clustered based on type or verticals (e.g., music, book, short videos, long videos, audio-only, live content, games, etc.), and a certain number of content items from each type may be returned as retrieved content items to diversify the types of content items being retrieved. The retrieved content items may have a balance of different types of content items.

User experience and engagement with retrieval of content items in response to a query can depend on whether the content item retrieval system can retrieve content items that the user is looking for in the query. Some retrieval strategies may be more suitable or better at finding content items that are most engaging to the user for the given query. However, it is a challenge to determine which retrieval strategy is better for a given query without prior labeled data.

One or more of the various retrieval strategies described above may be deployed by each of modules 310-316 as may be appropriate for the type of query received.

### Large Language Models

Various embodiments of one or more elements of query response system 300 as described herein (including, but not limited to, query planner agent 302, exploratory query module 314, and multistep query coordinator module 316) involve one or more large language models. A large language model is a type of artificial intelligence system that uses deep learning techniques, specifically transformers and self-attention mechanisms, to process and generate human-like text based on patterns learned from vast amounts of training data. A large language model has a transformer-based architecture. The transformer is one of the building blocks of a large language model. The transformer is a type of neural network that uses self-attention mechanisms to capture long-range dependencies in sequential data, such as text. The transformer architecture includes an encoder and a decoder, both having multiple (multi-head) attention layers and feed-forward neural network layers.

A large language model may include embeddings layer, an encoder, a decoder, and output layer. Embeddings layer converts the input text into numerical vector representations called embeddings. These embeddings represent the semantic and syntactic properties of words, allowing the large language model to understand the meaning and context of the input. Since the transformer architecture does not have an inherent notion of word order, positional encodings can be added to the input embeddings to provide the model with information about the position of each word in the sequence. The encoder processes the input sequence and creates a context-aware representation. The encoder includes multiple attention layers and feed-forward neural network layers. The decoder takes the encoded input representation from the encoder and generates the output sequence, token by token. The decoder can autoregressively generate output tokens one by one, attending to the encoded input and the previous output. The decoder includes multiple attention layers and feed-forward neural network layers. The output layer takes the representations from the decoder and can output probability distributions over the vocabulary for the next token in the sequence.

The attention layers allow the model to weigh different parts of the input sequence when producing the output. The attention mechanism enables the model to focus on the most relevant parts of the input for a given task, such as generating a coherent and contextually appropriate response. Multi-head attention is a technique that allows the large language model to attend to different representations of the input simultaneously. Multi-head attention may include several attention heads, each of which learns to attend to different aspects of the input, improving the model's ability to capture complex relationships and patterns.

Feed-forward neural network layers apply non-linear transformations to the output of the attention layers, allowing the model to learn more complex representations of the input data.

The input text, or a sequence of input tokens, received and processed by a large language model is referred to as a prompt. A prompt may include a sequence of words and characters. The words and characters may be converted by the large language model into a sequence of tokens.

### Example Query Planner Agent Using Large Language Model

In accordance with features of embodiments described herein, query planner agent 302 may be provided with the following prompt:
You are a helpful assistant. You are given a question inside <question> tags and a set of possible function inside <function-definition> tags.
Calling these functions is optional. Carefully consider the question and determine if one or more functions can be used to answer the question. Place your thoughts and reasoning behind your decision in <function-thoughts> tags.
If the given question lacks the parameters required by the function, point it out in <function-thoughts> tags.
If you wish to call a particular function, specify the name of the function and any arguments in a way that conforms to that function's schema inside <function-call> tags.
You can call multiple functions. In the end, a response to the query (e.g., content, content categories, names, free-form response, etc.) must be returned to the user.
Function calls should be in the following format: <function-thoughts>Calling func1 would be helpful because of . . . </function-thoughts> <function-call>[func1(params_name=params_value, params_name2=params_value2, . . . ), func2(params)]</function-call>, WITHOUT any answer.
If you do not wish to call any functions, say so in the <function-thoughts> tags followed by <function-call>none</function-call><answer> . . . </answer>. If and only if NO function calls are made, answer the question to the best of your ability inside <answer> tags. If you are unsure of the answer, say so in the <answer> tags.

Below is a list of function definitions (<function-definitions>) that are provided in the prompt for use by query planner agent 302.
1. def call_lexical_retrieval(query:str):
   Description: return the unique IDs of the content items. This function needs to be called if the user query is partial (i.e., not a complete word and/or not a complete name or title).
   Parameters: query (str): user query
   Returns: string: the unique IDs of content items relevant to the user query
2. def call_categorical_retrieval(query:str)
   Description: return the name or names of movies, series, and/or channels given the user query. This is helpful when the user query is a genre query or a free-form query requesting movies, series, or other content items.
   Parameters: query (str): user query
   Returns: string: name or names of content items
3. def call_data_enhanced_LLM(query:str)
   Description: return description or perform general chat with users; users can ask for a description of a movie or can simply chat with the system (“how are you?” “what is this movie about?”)
   Parameters: query (str): user query
   Returns: text or audio as a response to the query
4. def call_knowledge_graph_search(query:str):
   Description: return the name or names of movie, series, character, person, actor, director, etc., as the answer to the user query. Upon completion, call_categorical_retrieval or call_lexical_retrieval may be called
   Parameters: query (str): user query
   Returns: string: name or names of movie, series, character, person, actor, director, etc.

In one example, in response to a query “spiderman,” query planner agent 302 may generate the following function call:
<function-thoughts>
The query “spiderman” seems to be a partial query that contains the name of an entity, specifically a movie/series character. This suggests we might need to use a function that can retrieve relevant content based on this entity. The function call_lexical_retrieval comes to mind, as it can return the unique IDs of content relevant to the user query.
</function-thoughts>
<function-call>call_lexical_retrieval(query=“spiderman”)</function-call>

This results in the user query being submitted to the lexical query module 310 for response generation.

In another example, in response to a query “romcoms,” query planner agent 302 may generate the following function call:
<function-thoughts>
The query “romantic comedies” seems to be requesting movies or series that are of the genre known as romantic comedies. This suggests we might need to use a function that can retrieve relevant content based on this genre. The function call_categorical_retrieval comes to mind, as it can return the unique IDs of content relevant to the user query.
</function-thoughts>
<function-call>call_categorical_retrieval(query=“romcoms”)</function-call>

This results in the user query being submitted to the categorical query module 312 for response generation.

In another example, in response to a query “movies of the actor who played lawyer in breaking bad,” query planner agent 302 may generate the following function call:
<function-thoughts>
The query “movies of the actor who played lawyer in breaking bad” seems to be requesting movies featuring a specific actor who is identified by their role in a TV series. This suggests a need to use a function that can search for entities based on their relationships, such as call_knowledge graph_search, which can return the name or names of movies, series, characters, people, actors, directors, etc., as the answer to the user query. After getting the actor's name, the call_lexical_retrieval function can be called to obtain the IDs of content relevant to the actor.
</function-thoughts>
<function-call>call_knowledge_graph_search(query=“actor who played lawyer in breaking bad”), call_lexical_retrieval(query=result_from_previous_function)</function-call>

This results in the user query being submitted to the multistep query coordinator module 316 for response generation.

In yet another example, in response to a query “has spiderwick chronicles been released,” query planner agent 302 may generate the following function call:
<function-thoughts>
The query “has spiderwick chronicles been released” seems to be asking about the release status of a specific movie or series. This suggests the need to use a function that can provide information about the movie or series, such as call_lexical_retrieval; however this function might not directly answer the question about the release status. Alternatively, the function call_data_enhanced_LLM could be used, which can provide a descriptive response to the query, potentially answering the question about the release status of The Spiderwick Chronicles.
</function-thoughts>
<function-call>call_data_enhanced_LLM(query=“has spiderwick chronicles been released”)</function-call>

This results in the user query being submitted to the exploratory query module 314 for response generation.

In still another example, in response to a query “how are you doing today,” query planner agent 302 may generate the following function call:
<function-thoughts>
The query “how are you feeling today” is a general chat query that doesn't seem to be related to any specific content retrieval. This suggests the need to use a function that can provide a general response to the query, such as the function call_data_enhanced_LLM.
</function-thoughts>
<function-call>call data enhanced LLM(query=“how are you feeling today”)</function-call>

This results in the user query being submitted to the exploratory query module 314 for response generation.

It should be noted that, although query planner agent 302 is described as comprising a large language model that performs function calling, other forms of large language model, such one that uses zero short classification, could be implemented without departing from spirit or scope of embodiments described herein. Additionally, while in particular embodiments, query planner agent 302 does not provide a response to the query itself, query planner agent could be designed to provide limited responses, keeping in mind that a goal of query response system 300 is to reduce the cost of responding to a query by routing it to a least cost module for providing an acceptable and expected response to the query.

### Example Techniques for Providing User Query Responses in Multimedia Systems

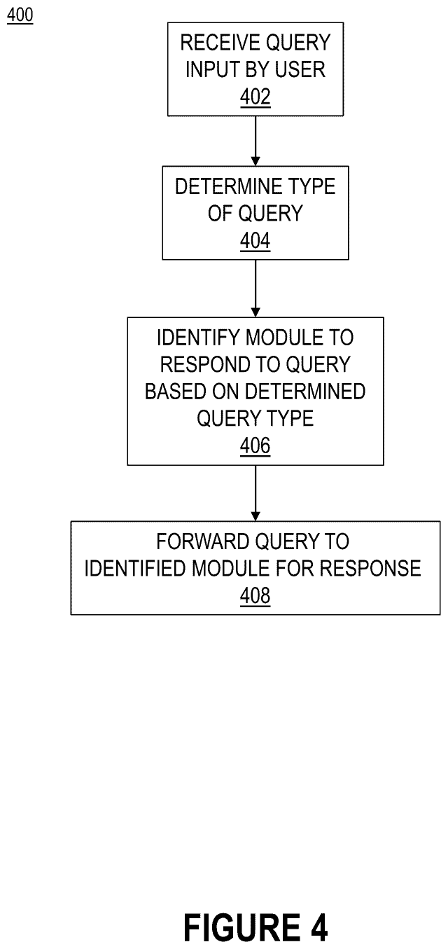

FIG. 4 is a flow diagram 400 of example operations performed in by query planner agent, such as query planner agent 302 (FIG. 3) according to some embodiments of the disclosure. In certain embodiments, one or more of the operations illustrated in FIG. 4 may be performed by one or more of the elements illustrated in FIGS. 1-3, for example.

In operation 402, a query is received from a user. As has been previously noted, the user query may be submitted in voice or text form. In some embodiments, the query may be preprocessed (depending on its form) prior to receipt by query planner agent. Alternatively, the user query may be received by the query planner agent in its original form, with any necessary processing being performed by the query planner agent.

In operation 404, a determination is made as to the type of the user query. For example, the query may be determined to be one of a lexical query, a categorical query, an exploratory query, or a multistep query. It will be recognized that other types of queries (and additional and/or different modules for processing such other types of queries) may be provided. It will be further recognized that fewer than all of the listed example types of queries (and modules for processing such queries) may also be supported without departing from the spirit or scope of embodiments described herein.

In operation 406, a module is identified for responding to the user query based on the determined type of the user query and in operation 408, the user query is forwarded to the identified module, which generates a response to the user query.

. For example, referring now also to FIG. 3, if the user query 306 is determined to be a lexical query, the user query may be forwarded to the lexical query module 310 (e.g., via an appropriate function call) for generating a response 308 to the user query. If the user query 306 is determined to be a categorical query, the user query may be forwarded to the categorical query module 312 (e.g., via an appropriate function call) for generating a response 308 to the user query. If the user query 306 is determined to be an exploratory query, the user query may be forwarded to the exploratory query module 314 (e.g., via an appropriate function call) for generating a response 308 to the user query. Finally, if the user query 306 is determined to be a multistep query, the user query may be forwarded to the multistep query coordinator module 316 (e.g., via an appropriate function call) for generating a response 308 to the user query.

Although the operations of the example method shown in and described with reference to FIG. 4 are illustrated as occurring once each and in a particular order, it will be recognized that the operations may be performed in any suitable order and repeated as desired. Additionally, one or more operations may be performed in parallel. Furthermore, the operations illustrated in FIG. 4 may be combined or may include more or fewer details than described.

It will also be recognized that query modules other than/in addition to module 316 may be designed to call other modules in order to fully respond to a particular user query.

### Example Computing Device

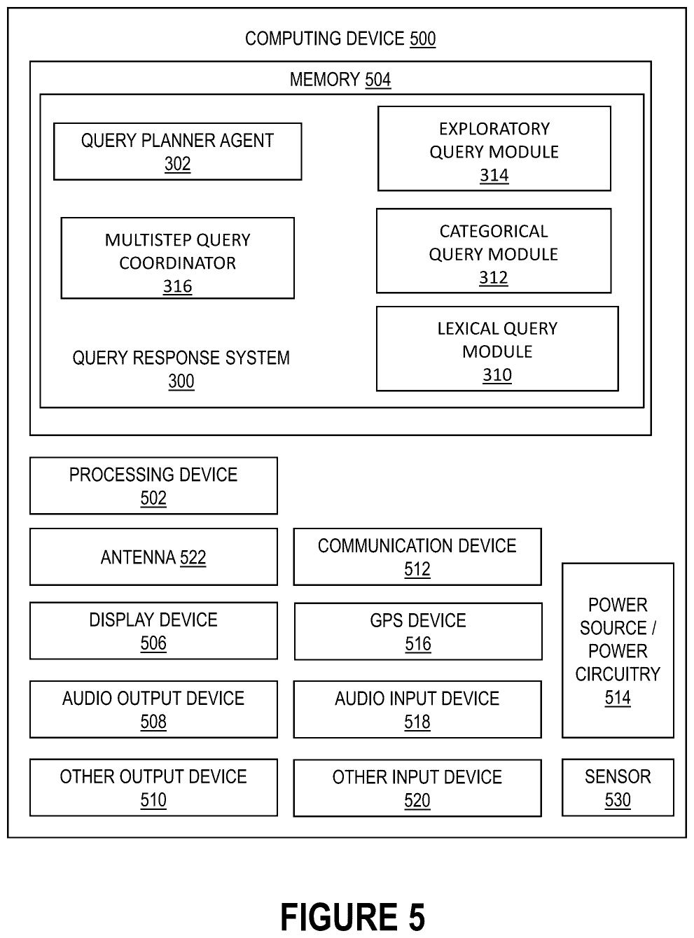

FIG. 5 is a block diagram of an example computing device 500, according to some embodiments of the disclosure. One or more computing devices 500 may be used to implement the functionalities described herein. A number of components are illustrated in the FIGURES as included in the computing device 500; however, it will be recognized that any one or more of these components may be omitted or duplicated, as suitable for the application. In some embodiments, some or all the components included in the computing device 500 may be attached to one or more motherboards. In some embodiments, some or all these components are fabricated onto a single system on a chip (SoC) die. Additionally, in various embodiments, the computing device 500 may not include one or more of the components illustrated in FIG. 5, and the computing device 500 may include interface circuitry for coupling to the one or more components. For example, the computing device 500 may not include a display device 506, and may include display device interface circuitry (e.g., a connector and driver circuitry) to which a display device 506 may be coupled. In another set of examples, the computing device 500 may not include an audio input device 518 or an audio output device 508 and may include audio input or output device interface circuitry (e.g., connectors and supporting circuitry) to which an audio input device 518 or audio output device 508 may be coupled.

The computing device 500 may include a processing device 502 (e.g., one or more processing devices, one or more of the same type of processing device, one or more of different types of processing device). The processing device 502 may include electronic circuitry that process electronic data from data storage elements (e.g., registers, memory, resistors, capacitors, quantum bit cells) to transform that electronic data into other electronic data that may be stored in registers and/or memory. Examples of processing device 502 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 500 may include a memory 504, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 504 includes one or more non-transitory computer-readable storage media. In some embodiments, memory 504 may include memory that shares a die with the processing device 502.

In some embodiments, memory 504 includes one or more non-transitory computer-readable media storing instructions executable to perform operations described herein and as shown in the FIGURES, such as FIG. 4.

Memory 504 may store instructions that encode one or more exemplary parts. Exemplary parts that may be encoded as instructions and stored in memory 504 are depicted. Exemplary parts may include one or more components of query response system 300 of FIG. 3. The instructions stored in the one or more non-transitory computer-readable media may be executed by processing device 502.

In some embodiments, memory 504 may store data, e.g., data structures, binary data, bits, metadata, files, blobs, etc., as described herein. In some embodiments, memory 504 may store one or more machine learning models (and or parts thereof) that are used in query response system 300 (FIG. 3). The machine learning models may include large language models described herein. Memory 504 may store training data for training the one or more machine learning models. Memory 504 may store input data (e.g., input tokens), output data (e.g., output tokens), intermediate outputs, intermediate inputs of one or more machine learning models. Memory 504 may store instructions to perform one or more operations of the machine learning model. Memory 504 may store one or more parameters used by the machine learning model. Memory 504 may store information that encodes how processing units of the machine learning model relate to each other.

In some embodiments, the computing device 500 may include a communication device 512 (e.g., one or more communication devices). For example, the communication device 512 may be configured for managing wired and/or wireless communications for the transfer of data to and from the computing device 500. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not. The communication device 512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are referred to as WiMAX networks, an acronym that stands for worldwide interoperability for microwave access, which is a certification mark for products that pass conformity and interoperability tests for the IEEE 802.16 standards. The communication device 512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 512 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 512 may operate in accordance with other wireless protocols in other embodiments. The computing device 500 may include an antenna 522 to facilitate wireless communications and/or to receive other wireless communications (such as radio frequency transmissions). The computing device 500 may include receiver circuits and/or transmitter circuits. In some embodiments, the communication device 512 may manage wired communications, such as electrical, optical, or any other suitable communication protocols (e.g., the Ethernet). As noted above, the communication device 512 may include multiple communication chips. For instance, a first communication device 512 may be dedicated to shorter-range wireless communications such as Wi-Fi or Bluetooth, and a second communication device 512 may be dedicated to longer-range wireless communications such as global positioning system (GPS), EDGE, GPRS, CDMA, WiMAX, LTE, EV-DO, or others. In some embodiments, a first communication device 512 may be dedicated to wireless communications, and a second communication device 512 may be dedicated to wired communications.

The computing device 500 may include power source/power circuitry 514. The power source/power circuitry 514 may include one or more energy storage devices (e.g., batteries or capacitors) and/or circuitry for coupling components of the computing device 500 to an energy source separate from the computing device 500 (e.g., DC power, AC power, etc.).

The computing device 500 may include a display device 506 (or corresponding interface circuitry, as discussed above). The display device 506 may include any visual indicators, such as a heads-up display, a computer monitor, a projector, a touchscreen display, a liquid crystal display (LCD), a light-emitting diode display, or a flat panel display, for example.

The computing device 500 may include an audio output device 508 (or corresponding interface circuitry, as discussed above). The audio output device 508 may include any device that generates an audible indicator, such as speakers, headsets, or earbuds, for example.

The computing device 500 may include an audio input device 518 (or corresponding interface circuitry, as discussed above). The audio input device 518 may include any device that generates a signal representative of a sound, such as microphones, microphone arrays, or digital instruments (e.g., instruments having a musical instrument digital interface (MIDI) output).

The computing device 500 may include a GPS device 516 (or corresponding interface circuitry, as discussed above). The GPS device 516 may be in communication with a satellite-based system and may receive a location of the computing device 500, as known in the art.

The computing device 500 may include a sensor 530 (or one or more sensors). The computing device 500 may include corresponding interface circuitry, as discussed above). Sensor 530 may sense physical phenomenon and translate the physical phenomenon into electrical signals that can be processed by, e.g., processing device 502. Examples of sensor 530 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 500 may include another output device 510 (or corresponding interface circuitry, as discussed above). Examples of the other output device 510 may include an audio codec, a video codec, a printer, a wired or wireless transmitter for providing information to other devices, haptic output device, gas output device, vibrational output device, lighting output device, home automation controller, or an additional storage device.

The computing device 500 may include another input device 520 (or corresponding interface circuitry, as discussed above). Examples of the other input device 520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 500 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 500 may be any other electronic device that processes data.

### Select Examples

Example 1 provides a computer-implemented method including receiving by a query planner agent of a query response system a user query including a request for a response; determining a type of the received user query; identifying one of a plurality of response modules including the query response system based on the determined type of the received user query; and forwarding the received user query to the identified one of the plurality of response modules.
Example 2 provides the computer-implemented method of example 1, in which the determined type of the received user query includes one of a lexical query, a categorical query, an explanatory query, and a multistep query.
Example 3 provides the computer-implemented method of example 1 or 2, in which the received user query includes a lexical query and the response includes at least one content item.
Example 4 provides the computer-implemented method of any one of examples 1-3, in which the received user query includes a categorical query and the response includes at least one content item.
Example 5 provides the computer-implemented method of any one of examples 1-4, in which the received user query includes a name or a partial name of at least one of a person, a movie, and a television series and in which the identified one of the plurality of response modules includes a lexical search engine.
Example 6 provides the computer-implemented method of any one of examples 1-5, in which the received user query includes at least one of a genre, a location, and a content description and in which the identified one of the plurality of response modules includes a categorical search engine.
Example 7 provides the computer-implemented method of any one of examples 1-6, in which the forwarding includes issuing a function call to the identified one of the plurality of response modules.
Example 8 provides the computer-implemented method of example 7, in which the function call includes the received user query.
Example 9 provides the computer-implemented method of any one of examples 1-8, in which at least one and less than all of the plurality of response modules include a large language model.
Example 10 provides the computer-implemented method of any one of examples 1-9, in which the query planner agent includes a large language model.
Example 11 provides the computer-implemented method of any one of examples 1-10, in which the received user query is at least one of a voice query and a text query.
Example 12 provides one or more non-transitory computer-readable media storing instructions that, when executed by one or more processors, cause the one or more processors to: receive by a query planner agent of a query response system a user query including a request for a response; determine a type of the received user query; identify one of a plurality of response modules including the query response system based on the determined type of the received user query; and forward the received user query to the identified one of the plurality of response modules, in which the determined type of the received user query includes one of a lexical query, a categorical query, an explanatory query, and a multistep query; and in which each of the determined types has associated therewith a different one of the plurality of response modules.
Example 13 provides the one or more non-transitory computer-readable media of example 12, in which the received user query includes a name or a partial name of at least one of a person, a movie, and a television series and in which the identified module for response includes a lexical search engine.
Example 14 provides the one or more non-transitory computer-readable media of example 12 or 13, in which the received user query includes at least one of a genre, a location, and a content description and in which the identified one of the plurality of response modules includes a categorical search engine.
Example 15 provides the one or more non-transitory computer-readable media of any one of examples 12-14, in which the forwarding includes issuing a function call to the identified one of the plurality of response modules, in which the function call includes the received user query.
Example 16 provides the one or more non-transitory computer-readable media of any one of examples 12-15, in which at least one and less than all of the plurality of response modules include a large language model.
Example 17 provides the one or more non-transitory computer-readable media of any one of examples 12-16, in which the query planner agent includes a large language model.
Example 18 provides a system, including a query planner agent; and a plurality of query response modules each associated with a different one of a plurality of query types, in which at least one but not all of the query response modules includes a large language model and at least one but not all of the query response modules includes a search engine; in which the query planner agent is configured to: receive a user query including a request for a response; determine one of the query types of the received user query; identify the one of a plurality of response modules associated with the determined one of the query types of the received user query; and providing the received user query to the identified one of the plurality of response modules.
Example 19 provides the system of example 18, in which the query planner agent includes a large language model.
Example 20 provides the system of example 19, in which the forwarding includes issuing a function call to the identified one of the response modules, in which the function call includes the received user query.

### Variations and Other Notes

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure considering the above detailed description.

For purposes of explanation, specific numbers, materials, and configurations are set forth to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. These operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for case of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” refer to being within +/−20% of a target value as described herein or as known in the art. Similarly, terms indicating orientation of various elements, e.g., “coplanar,” “perpendicular,” “orthogonal,” “parallel,” or any other angle between the elements, refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. A computer-implemented method comprising:
receiving by a query planner agent of a multimedia content retrieval system a user query comprising a request for a response, the multimedia content retrieval system comprising a portion of a multimedia system for presenting multimedia content items to the user via a media system comprising a display device and a remote control unit for controlling operation of the media system and wherein the user query is entered using the remote control unit;
determining a type of the received user query;
identifying one of a plurality of response modules comprising the multimedia content retrieval system based on the determined type of the received user query; and
forwarding the received user query to the identified one of the plurality of response modules;
wherein the response comprises an indication of all of the multimedia content items that satisfy the user query.

2. The computer-implemented method of claim 1, wherein the determined type of the received user query comprises one of a lexical query, a categorical query, an explanatory query, and a multistep query.

3-4. (canceled)

5. The computer-implemented method of claim 1, wherein the received user query comprises a name or a partial name of at least one of the multimedia content items and a person associated with at least one of the multimedia content items and wherein the identified one of the plurality of response modules comprises a lexical search engine.

6. The computer-implemented method of claim 1, wherein the received user query comprises at least one of a genre of at least one of the multimedia content items, a location with which at least one of the multimedia content items is associated, and a content description of at least one of the multimedia content items, and wherein the identified one of the plurality of response modules comprises a categorical search engine.

7. The computer-implemented method of claim 1, wherein the forwarding comprises issuing a function call to the identified one of the plurality of response modules.

8. The computer-implemented method of claim 7, wherein the function call includes the received user query.

9. The computer-implemented method of claim 1, wherein at least one and less than all of the plurality of response modules comprise a large language model.

10. The computer-implemented method of claim 1, wherein the query planner agent comprises a large language model.

11. The computer-implemented method of claim 1, wherein the remote control unit includes a microphone and the received user query is a voice query entered using the microphone.

12. One or more non-transitory computer-readable media storing instructions that, when executed by one or more processors, cause the one or more processors to:
receive by a query planner agent of a multimedia content retrieval system a user query comprising a request for a response, the multimedia content retrieval_system comprising a portion of a multimedia system for presenting multimedia content items to the user via a media system comprising a display device and a remote control unit for controlling operation of the media system and wherein the user query is entered using the remote control unit;
determine a type of the received user query;
identify one of a plurality of response modules comprising the multimedia content retrieval system based on the determined type of the received user query; and
forward the received user query to the identified one of the plurality of response modules,
wherein the determined type of the received user query comprises one of a lexical query, a categorical query, an explanatory query, and a multistep query; and
wherein each of the determined types has associated therewith a different one of the plurality of response modules; and
wherein the response comprises an indication of all of the multimedia content items that satisfy the user query.

13. The one or more non-transitory computer-readable media of claim 12, wherein the received user query comprises a name or a partial name of at least one of the multimedia content items and a person associated with at least one of the multimedia content items and wherein the identified one of the plurality of response modules comprises a lexical search engine.

14. The one or more non-transitory computer-readable media of claim 12, wherein the received user query comprises at least one of a genre of at least one of the multimedia content items, a location with which at least one of the multimedia content items is associated, and a content description of at least one of the multimedia content items, and wherein the identified one of the plurality of response modules comprises a categorical search engine.

15. The one or more non-transitory computer-readable media of claim 12, wherein the forwarding comprises issuing a function call to the identified one of the plurality of response modules, wherein the function call includes the received user query.

16. The one or more non-transitory computer-readable media of claim 12, wherein at least one and less than all of the plurality of response modules comprise a large language model.

17. The one or more non-transitory computer-readable media of claim 12, wherein the remote control unit includes a microphone and the received user query is a voice query entered by the user speaking into the microphone.

18. A multimedia content retrieval system comprising a portion of a multimedia system for presenting multimedia content items to a user via a media system comprising a display device and a remote control unit for controlling operation of the media system, the multimedia content retrieval system comprising:
a query planner agent; and
a plurality of query response modules each associated with a different one of a plurality of query types, wherein at least one but not all of the query response modules comprises a large language model and at least one but not all of the query response modules comprises a search engine;
wherein the query planner agent is configured to:
receive a user query comprising a request for a response, wherein the user query is entered using the remote control unit;
determine one of the query types of the received user query;
identify the one of a plurality of response modules associated with the determined one of the query types of the received user query; and
providing the received user query to the identified one of the plurality of response modules;
wherein the response comprises an indication of all of the multimedia content items that satisfy the user query.

19. The multimedia content retrieval system of claim 18, wherein the query planner agent comprises a large language model.

20. The multimedia content retrieval system of claim 19, wherein the remote control unit includes a microphone and the received user query is a voice query entered by the user speaking into the microphone.

21. The computer-implemented method of claim 1, wherein the indication comprises a list of all of the multimedia content items that satisfy the user query.

22. The computer-implemented method of claim 21, wherein the list is displayed on the display device.
